(19) United States
(12) Patent Application Publication
(10) Pub. No.: US 2020/0000269 A1
(43) Pub. Date: Jan. 2, 2020

(54) LIQUID BEVERAGE MANUFACTURING DEVICE

(71) Applicant: NN6CORPORATION, Daejeon (KR)

(72) Inventor: Seung Hui GANG, Guri-si (KR)

(21) Appl. No.: 16/483,116

(22) PCT Filed: Jun. 20, 2017
(86) PCT No.: PCT/KR2017/006484

§ 371 Date: Aug. 2, 2019

(30) Foreign Application Priority Data
Feb. 2, 2017 (KR) 20-2017-0000579

(51) Int. Cl. A47J 31/40; A47J 31/46

(52) U.S. Cl. CPC A47J 31/401; B65D 47/20; A47J 31/46

(57) ABSTRACT

Provided is a liquid beverage manufacturing device for discharging a liquid beverage from a pressure container filled with the liquid beverage to enable tasting the liquid beverage. The device includes: the pressure container in which high pressure nitrogen and a liquid beverage are filled and sealed and from which the nitrogen and the liquid beverage are discharged, through a discharge tube, by internal pressure when the discharge tube is pushed inwards; and the jig having a discharge hole, into which the discharge tube is inserted. In a state in which the jig is placed on the top surface of the cup, the discharge tube can be formed to be inserted into the discharge hole up to a predetermined depth and then is pushed inwards of the pressure container without being inserted any further such that the liquid beverage passes through the discharge hole and is discharged into the cup.

### TECHNICAL FIELD

The present invention relates to a liquid beverage manufacturing device which discharges a liquid beverage from a pressure container, which is filled with the liquid beverage, using a jig so as to allow a user to drink the liquid beverage.

### BACKGROUND ART

Generally, liquid beverages are sold in bottles, cans, or the like, and most of them are sealed while being filled with the liquid beverages under atmospheric pressure.

Recently, various beverages are sold, but coffee-related beverages are decidedly higher in terms of all indexes such as sales volume.

A variety of coffee-related beverages are developed according to various brewing methods and added additives and are being sold.

Generally, according to a coffee brewing method, coffee is classified into drip coffee, French press coffee, Moka pot coffee, espresso coffee, and the like, but recently, cold-brew coffee that is made using a low temperature brewing method, also called Dutch coffee, is popular. The former types of coffee are brewed using a method that brews coffee in a short time by supplying hot boiling water or steam to coffee, which is a traditional coffee brewing method, and the latter type of coffee is brewed using a method that brews coffee for a long time at room temperature.

Since tools for roasting and grinding coffee beans and brewing coffee are required to personally brew coffee, it is very inconvenient. To make up for the inconvenience, so-called coffee capsule has emerged. The coffee capsule, which has coffee grounds and a filter contained therein and is sealed and packaged, is inserted into an exclusive machine so that coffee is brewed in an espresso manner.

Recently, so-called Nitro-coffee is popular. Since the Nitro coffee is made by mixing the above-described cold-brew coffee, which is made using a low temperature brewing method, with nitrogen just like draft beer, foam is formed like draft beer.

However, to mix a liquid beverage, such as coffee, with nitrogen gas, a machine which is charged with high-pressure nitrogen gas and is able to supply the nitrogen gas is necessarily needed, and thus it is difficult for users to be personally equipped with the machine in terms of cost.

### DISCLOSURE

### Technical Problem

The present invention is directed to providing a liquid beverage manufacturing device which simply discharges a liquid beverage, which is charged with nitrogen in a pressure container, to a cup using a jig in order to enjoy the liquid beverage.

### Technical Solution

One aspect of the present invention provides a liquid beverage manufacturing device which includes a pressure container which is filled with high pressure nitrogen and a liquid beverage and sealed and allows the nitrogen and the liquid beverage to be discharged through a discharge tube due to an internal pressure when the discharge tube is pushed toward an inside of the pressure container and a jig including a discharge hole into which the discharge tube is inserted, wherein, while the jig is positioned on an upper surface of a cup, the discharge tube is inserted into the discharge hole by a predetermined depth and pushed toward the inside of the pressure container without further insertion, and thus the liquid beverage is discharged to an inside of the cup through the discharge hole.

Another aspect of the present invention provides a liquid beverage manufacturing device which includes a pressure container which is filled with high pressure nitrogen and a liquid beverage and sealed and allows the nitrogen and the liquid beverage to be discharged through a discharge tube due to an internal pressure when the discharge tube is pushed toward an inside of the pressure container and a jig which has the pressure container insertion-mounted therein and includes a discharge hole formed in one end portion thereof so that the discharge tube is inserted into the discharge hole and a plurality of wing members which are formed on a lateral surface of the jig and are mounted on an upper surface of a cup to support the pressure container, wherein, while the jig is mounted on the upper surface of the cup, the discharge tube is inserted into the discharge hole by a predetermined depth and is pushed toward the inside of the pressure container without further insertion, and thus the liquid beverage is discharged to an inside of the cup through the discharge hole.

The plurality of wing members may be hinge-connected with the lateral surface of the jig or detachably coupled thereto.

The discharge hole may include an insertion part into which the discharge tube is inserted and a nozzle which has a reduced diameter so that an end portion of the discharge tube is caught therein.

A diameter of the discharge hole may be linearly decreased.

The discharge hole may include a spiral groove or protrusion formed therein so that the discharged liquid beverage is spirally guided.

The jig may be formed in a disc shape to cover an entirety of the upper surface of the cup.

The jig may include a gas hole that allows an upper portion of the jig to communicate with a lower portion thereof so that the inside of the cup communicates with an outside thereof while the jig covers the entirety of the upper surface of the cup.

The jig may be formed in a hemispherical shape and include an insertion groove formed in a central portion thereof so that a part or an entirety of the pressure container is inserted thereinto.

The jig may be formed in a stopper shape.

The jig may include a stopper detachably coupled to a side opposite the discharge hole, wherein the stopper may be made of a flexible material so that a rear portion of the pressure container is pushed without separation of the stopper.

The cup may contain water to be mixable with the liquid beverage.

### Advantageous Effects

According to the present invention, the effects are as follows.

(1) The liquid beverage manufacturing device allows individuals to make and enjoy nitro coffee at home, rather than a workplace, by themselves.

(2) The present invention provides a device including a small-sized pressure container and a jig so as to be highly portable and convenient to use.

### DESCRIPTION OF DRAWINGS

FIG. 1 shows cross-sectional views before and after use of a liquid beverage manufacturing device according to a first embodiment of the present invention.

FIG. 2 is a partial cut-out perspective view of the liquid beverage manufacturing device according to the first embodiment of the present invention.

FIG. 3 is an exploded perspective view of the liquid beverage manufacturing device according to the first embodiment of the present invention.

FIG. 4 is a partial cut-out perspective view of a liquid beverage manufacturing device according to a second embodiment of the present invention.

FIG. 5 is an exploded perspective view of the liquid beverage manufacturing device according to the second embodiment of the present invention.

FIG. 6 is a partial cut-out perspective view of a liquid beverage manufacturing device according to a third embodiment of the present invention.

FIG. 7 is an exploded perspective view of the liquid beverage manufacturing device according to the third embodiment of the present invention.

FIG. 8 shows cross-sectional views of various examples of discharge holes provided in the liquid beverage manufacturing device according to the embodiments of the present invention.

FIG. 9 is a perspective view illustrating another type of the discharge hole as shown in FIG. 8.

FIG. 10 is a perspective view of a liquid beverage manufacturing device according to a fourth embodiment of the present invention.

FIG. 11 is a perspective view of a liquid beverage manufacturing device according to a fifth embodiment of the present invention.

FIG. 12 is a cross-sectional view of a liquid beverage manufacturing device according to a sixth embodiment of the present invention.

FIG. 13 is a partial cut-out perspective view of a liquid beverage manufacturing device according to a seventh embodiment of the present invention.

FIG. 14 is a perspective view illustrating a use state of the liquid beverage manufacturing device according to the seventh embodiment of the present invention.

FIG. 15 shows cross-sectional views before and after use of a liquid beverage manufacturing device according to an eighth embodiment of the present invention.

### MODES OF THE INVENTION

Hereinafter, embodiments that are easily performed by those skilled in the art will be described in detail with reference to the accompanying drawings. However, the embodiments of the present invention may be implemented in several different forms and are not limited to the embodiments described herein. In addition, parts irrelevant to descriptions will be omitted in the drawings to clearly explain the embodiments of the present invention. Similar parts are denoted by similar reference numerals throughout this specification.

In the specification, it should be further understood that the term “comprises” or “have” used in this specification specifies the presence of stated features, numerals, steps, operations, components, parts, or a combination thereof, but do not preclude the presence or addition of one or more other features, numerals, steps, operations, components, parts, or a combination thereof. Further, when a part of a layer, region, or component is referred to as being “on” another part, the part of a layer, region, or component may be referred to as being “directly on” another part or an intervening element may be present therebetween. In contrast, when a part of a layer, region, or component is referred to as being “under” another part, the part of a layer, region, or component may be referred to as being “directly under” another part or an intervening element may be present therebetween.

Hereinafter, a liquid beverage manufacturing device according to one embodiment of the present invention will be described in more detail with respect to the drawings.

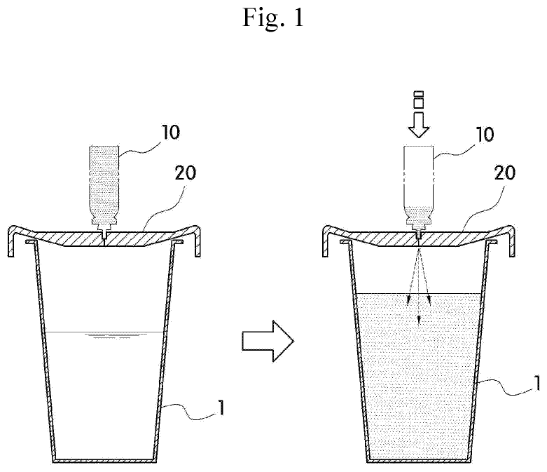

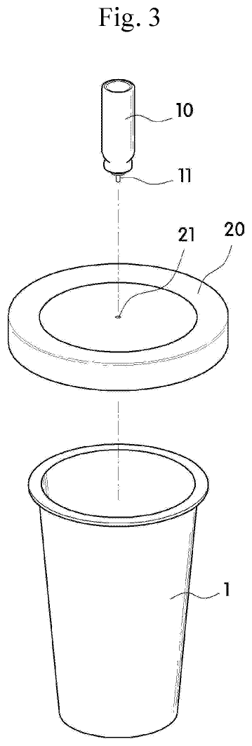

As shown in FIGS. 1 to 3, a liquid beverage manufacturing device according to a first embodiment of the present invention includes a pressure container 10 and a jig 20.

Referring to FIGS. 1 to 3, the pressure container 10 is filled with high pressure nitrogen and a liquid beverage, such as coffee, and sealed, and when a discharge tube 11 is pushed toward the inside of the pressure container 10, discharges the compressed nitrogen and the liquid beverage through the discharge tube 11 due to an internal pressure.

In this case, the pressure container 10 is formed in a cylindrical Bombe shape and has the discharge tube 11 formed to protrude from one end thereof. A valve connected with the discharge tube 11 is formed in the pressure container 10 and is designed to be opened when the discharge tube 11 is pushed toward the inside of the pressure container 10 due to a force applied to the discharge tube 11. Since the pressure container 10 is a generally well-known pressure container, detailed descriptions thereof will be omitted.

The pressure container 10 is filled with high pressure nitrogen and coffee that is a liquid beverage. As described above, the coffee is coffee for making nitro coffee, and since the cold-brew coffee, which is made using a low temperature brewing method, is mixed with nitrogen like draft beer, foam is formed.

In this case, in order to discharge the nitro coffee, the discharge tube 11 should be opened so that the compressed nitrogen and the coffee are discharged from the discharge tube 11 while the discharge tube 11 of the pressure container 10 is pushed rearward. Further, since a spring mounted in the valve of the pressure container 10 pushes the discharge tube 11 outward, a force that overcomes an elastic force of the spring should be applied, and thus the discharge tube 11 is pushed. Therefore, when two conditions, in which a force that overcomes the elastic force of the spring is applied and a part of the discharge port of the discharge tube 11 is opened, are simultaneously satisfied, the fluid in the pressure container is discharged.

In this case, since the elastic force of the spring endures a pressure of the compressed nitrogen supplied in the pressure container, a significantly high pressure should be set to the spring generally.

Referring to FIGS. 1 to 3, the jig 20 is mounted on an upper surface of the cup 1 to which the liquid beverage is discharged and includes a discharge hole 21 into which the discharge tube 11 is inserted.

In this case, the jig 20 is formed in a circular shape to cover an entirety of the open upper surface of the cup 1 and has an edge portion curved downward to help the jig mounted on the upper surface of the cup 1. An area of the jig 20 is much greater than an area of the upper surface of the cup 1.

The discharge hole 21 is formed in a central portion of the jig 20 and passes through upper and lower surfaces of the jig 20.

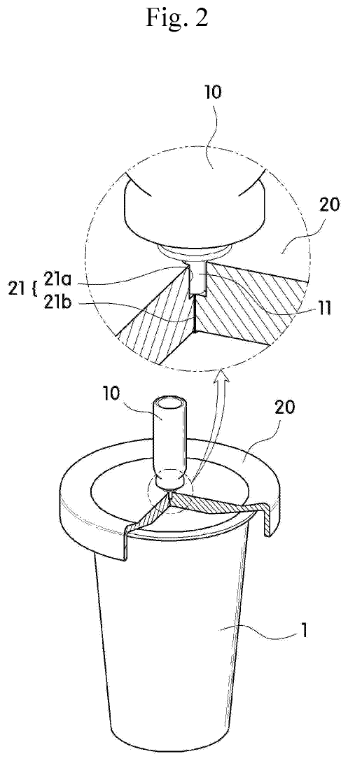

In this case, referring to FIG. 2, the discharge tube 11 is inserted into the discharge hole 21 by a predetermined depth and pushed toward the inside of the pressure container 10 without further insertion, and the liquid beverage is discharged through the discharge hole 21.

The discharge hole 21 includes an insertion part 21a into which the discharge tube 11 is inserted and a nozzle 21b which has a reduced diameter so that an end portion of the discharge tube 11 is caught therein. The diameter of the insertion part 21a is large enough to accommodate the discharge tube 11, and the nozzle 21b is formed to block the discharge tube 11 from entering more and has a diameter that allows the liquid beverage to pass through the nozzle. Therefore, as shown in FIG. 2, when the discharge tube 11 of the pressure container 10 is inserted into the discharge hole 21, the discharge tube 11 is continuously inserted into an end portion of the insertion part 21a and is blocked from being inserted due to the small diameter of the nozzle 21b. In this state, when the pressure container 10 is pushed more, the discharge tube 11 is pushed toward the inside of the pressure container 10, and the valve is opened.

In this case, when the pressure container 10 is opened, the nitrogen and the coffee are discharged and sprayed into the cup 1 through the nozzle 21b due to an inner pressure of the pressure container 10.

In this case, since the nitro coffee sprayed into the cup 1 is a mixture of the compressed nitrogen and the coffee, foam is formed on the upper surface of the nitro coffee like draft beer.

The compressed nitrogen and the coffee in the pressure container 10 are continuously discharged and sprayed until the internal pressure is equal to an atmospheric pressure, and when the internal pressure is equal to the atmospheric pressure, the discharging and spraying are stopped.

Referring to FIG. 1, a user supplies a predetermined amount of water in the cup 1 and mounts the jig 20 on the upper surface of the cup 1. Next, the discharge tube 11 of the pressure container 10 is aligned with and inserted into the discharge hole 21 of the jig 20, and a force is applied to push the pressure container 10.

In this case, when the discharge tube 11 is pushed toward the inside of the pressure container 10, the valve is opened, and the compressed nitrogen and the concentrated coffee in the pressure container 10 are discharged and sprayed into the cup 1. When the compressed nitrogen and the concentrated coffee in the pressure container 10 are completely discharged, a user removes the pressure container 10 and the jig 20 and enjoys the nitro coffee.

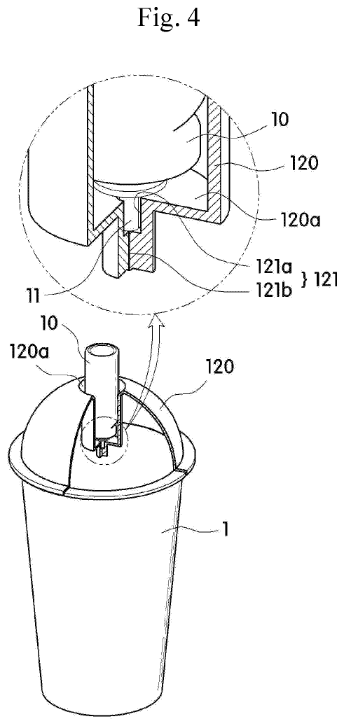

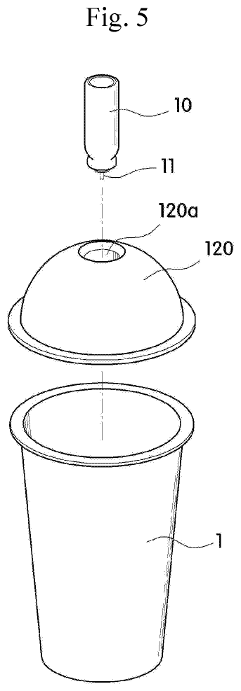

Referring to FIGS. 4 and 5, a second embodiment of a liquid beverage manufacturing device according to the present invention is shown.

In this case, a pressure container 10 is formed in the same shape as in the above-described embodiment.

In this case, a jig 120 is formed in a hemispherical shape and has an insertion groove 120a formed in a central portion thereof so that an entirety or a part of the pressure container 10 is inserted thereinto. In this case, referring to FIG. 4, the insertion groove 120a is provided to have a depth to which about two thirds of the pressure container 10 may be inserted.

In this case, the jig 120 includes a discharge hole 121 in a similar manner to the first embodiment, and the discharge hole 121 includes an insertion part 121a and a nozzle 121b. The discharge tube 11 is inserted into the insertion part 121a, and the nozzle 121b has a reduced diameter, and thus an end portion of the discharge tube 11 is caught therein so that the discharge tube is not inserted more. Therefore, when the discharge tube 11 is blocked by the nozzle 121b, the discharge tube is opened, and thus the nitrogen and the coffee in the pressure container 10 are discharged and sprayed into the cup 1 through the nozzle 121b.

Referring to FIG. 5, in the liquid beverage manufacturing device according to the second embodiment of the present invention, the jig 120 is mounted on an upper portion of the cup 1, and the pressure container 10 is inserted into the insertion groove 120a of the jig 120. In this case, since a diameter of the insertion groove 120a is similar to a diameter of the pressure container 10, the pressure container 10 is inserted into the insertion groove 120a, and the discharge tube 11 is simultaneously automatically inserted into the discharge hole 121. In this state, when a user pushes a rear portion of the pressure container 10, nitro coffee is made.

Here, since an entirety or a part of the pressure container 10 is inserted into the insertion groove 120a of the jig 120, inconvenience when a user applies a force while the discharge tube 11 of the pressure container 10 fits into the discharge hole 121 can be reduced.

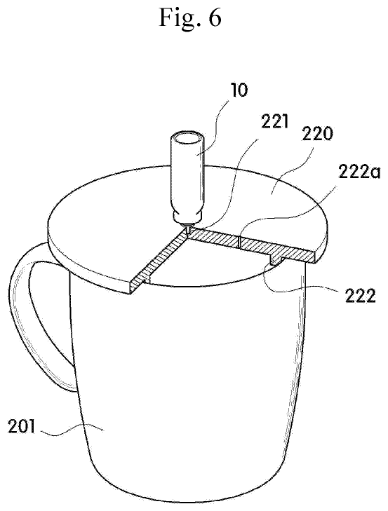

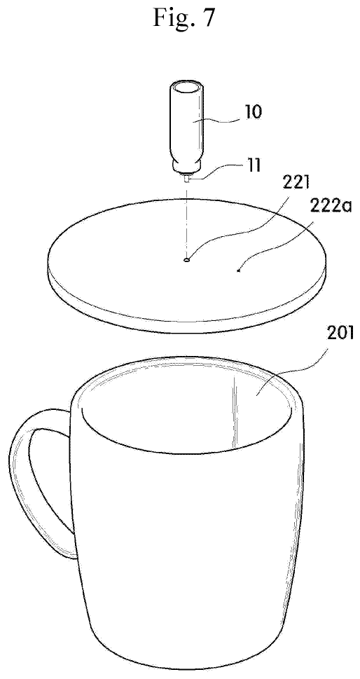

Referring to FIGS. 6 and 7, a fourth embodiment of a liquid beverage manufacturing device according to the present invention is shown.

Referring to FIGS. 6 and 7, the fourth embodiment of the liquid beverage manufacturing device includes a pressure container 10 and a jig 220.

The pressure container 10 has the same configuration as in the above-described embodiments.

The jig 220 has a disc shape to completely cover an upper surface of a cup 201 and a discharge hole 221 formed in a central portion thereof so that a discharge tube 11 of the pressure container 10 is inserted thereinto to allow nitro coffee to be discharged and sprayed into the cup 201. The discharge hole 221 also has the same configuration as the above-described embodiments.

In this case, the jig 220 includes a gas hole 222a allowing an upper portion of the jig 220 to communicate with a lower portion thereof. Thus, in a state in which the inside of the cup 201 is sealed by the jig 220, when the compressed nitrogen and the coffee are sprayed, an internal pressure of the cup 201 can be prevented from being sharply increased.

In this case, a guide protrusion 222, which allows the jig 220 to be mounted to an accurate position when the jig 220 is mounted on the cup 201, is formed on a lower surface of the jig 220 in a ring shape along a circular arc. The guide protrusion 222 allows a user to mount the jig 220 to an accurate position of the upper surface of the cup 201.

Referring to FIG. 7, the user supplies a predetermined amount of water into the cup 201 and mounts the jig 220 to cover the upper surface of the cup 201. In this case, the jig 220 is positioned at the accurate position of the upper surface of the cup 201 by the guide protrusion 222.

While the jig 220 is mounted, the user inserts the discharge tube 11 of the pressure container 10 into the discharge hole 221 of the jig 220. When the pressured container 10 is pushed downward by applying a force, the compressed nitrogen and the coffee in the pressure container 10 are discharged and sprayed into the cup 201, and thus the nitro coffee is made.

In this case, since a state in which the jig 220 is mounted on the upper surface of the cup 201 is maintained by the guide protrusion 222, coffee can be stably brewed while the jig 220 does not escape from an original position when a force is applied. Further, the gas hole 222a allows the internal pressure of the cup 201 to be stable.

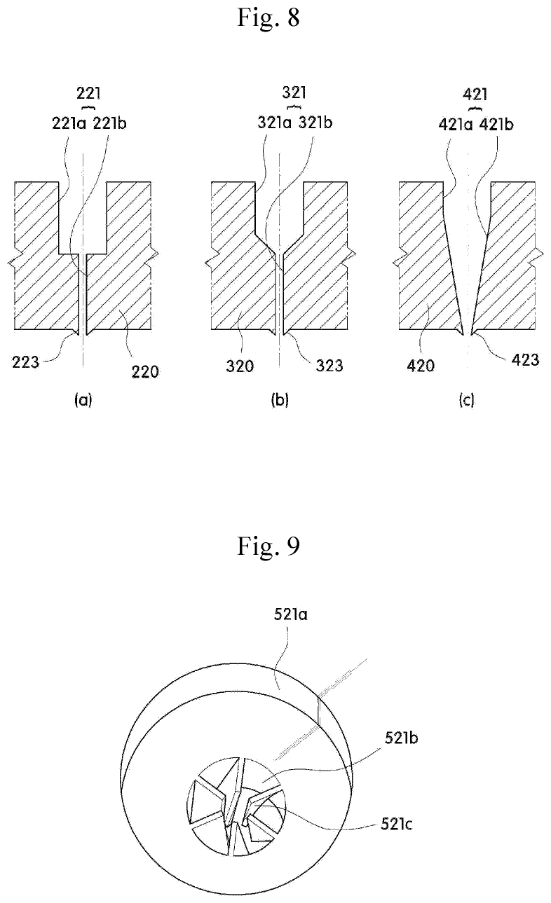

Meanwhile, referring to FIG. 8, various discharge holes 221, 321, and 421 formed in the jigs 220, 320, and 420 are shown. As described above, the discharge tubes 11 of the pressure containers 10 are inserted into the discharge hole 221,321, and 421, and the compressed nitrogen and the coffee in the pressure containers 10 pass through the discharge holes.

In FIG. 8A, the discharge tube 11 formed in the jig 220 includes an insertion part 221a and a nozzle 221b, wherein the discharge tube 11 is inserted into the insertion part 221a, and the nozzle 221b has a reduced diameter so that the discharge tube 11 is caught therein and prevented from being inserted into the nozzle 221b. That is, the discharge hole 221 has a stepped portion having a nonlinearly changed diameter. Further, a volcanic-crater-shaped protrusion 223 is formed on an end portion of the nozzle 221b to allow a discharged fluid to move linearly.

In FIG. 8B, a discharge hole 321 is formed in a jig 320, but a boundary surface between an insertion hole 321a and a nozzle 321b is formed to have a linearly reduced diameter. Therefore, when the discharge tube 11 of the pressure container 10 is inserted into an end portion of the insertion hole 321a until the discharge tube 11 is no longer inserted, the fluid is discharged, but unlike in FIG. 8A, since the diameter is linearly reduced rather than sharply reduced, fluid can be smoothly discharged as soon as the discharging of the fluid starts. Furthermore, a crater-shaped protrusion 323 is formed on an end of the nozzle 321b.

In FIG. 8C, an insertion part 421a is the same as described above, but a nozzle 421b has a linearly reduced diameter as a whole. Therefore, the fluid discharged from the discharge tube 11 flows very smoothly, but a pressure applied to an end of the nozzle 421b may increase. A crater-shaped protrusion 423 is provided on an end portion of the nozzle 421b as described above.

FIG. 9 shows another type of a discharge hole 521a and 521b. In this case, a spiral groove or protrusion 521c may be provided in the discharge hole 521b to spirally guide a discharged liquid beverage.

Further, a plurality of guide partition walls 521c are formed to protrude from the discharge holes 521a and 521b of the jig, wherein the plurality of guide partition walls 521c are protrusions that allow an end portion of the discharge tube 11 of the pressure container 10 to be caught therein and fluid to be discharged. The plurality of guide partition walls 521c may be formed in parallel along the discharge holes 521b and may be formed to be inclined so that the fluid is spirally guided. Further, the discharge holes 521a and 521b may have uniform diameters or may have a linearly reduced diameter.

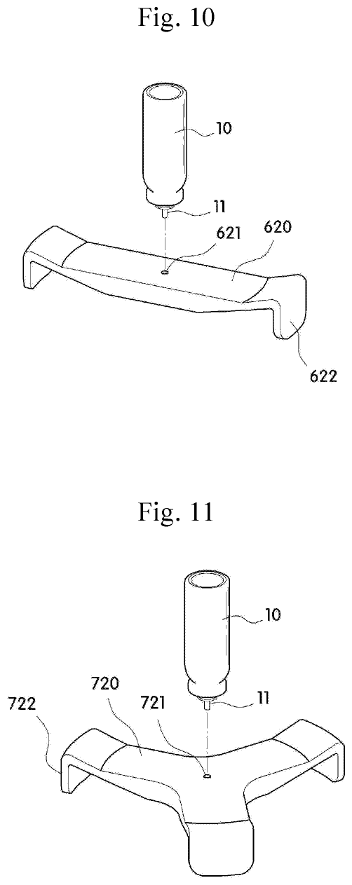

Meanwhile, referring to FIG. 10, the liquid beverage manufacturing device according to the fourth embodiment of the present invention is shown. The liquid beverage manufacturing device includes a pressure container 10 and a jig 620.

In the same manner as described above, the pressure container 10 includes a discharge tube 11 for discharging and spraying the compressed nitrogen and coffee.

The jig 620 is formed in an 1 shape when viewed from above which is a very convenient shape. The jig 620 includes a discharge hole 621 formed in a central portion thereof so that the discharge tube 11 is inserted thereinto. The discharge hole 621 may have the above-described various shapes.

The jig 620 is formed in a straight shape to occupy a minimum space when being carried and has curved portions 622 formed on both ends thereof and curved downward to limit movement on the top of the cup in a longitudinal direction.

Further, referring to FIG. 11, a liquid beverage manufacturing device according to a fifth embodiment of the present invention is shown. The liquid beverage manufacturing device includes a pressure container 10 and a jig 720.

In the same manner as described above, the pressure container 10 includes a discharge tube 11 for discharging and spraying compressed nitrogen and coffee.

The jig 720 is formed in a tripod shape when viewed from above, wherein the tripod shape has legs formed at regular angles of 120° and is a more convenient shape than other shapes or a hemispheric shape. The jig 720 includes a discharge hole 721 formed in a central portion thereof so that the discharge tube 11 is inserted thereinto. The discharge hole 721 may have the above-described various shapes.

The jig 720 has a shape that compensates for the shape of the straight jig 620 that is unstable in directions except for a longitudinal direction. Further, curved portions 722 are formed on both end portions thereof and curved downward to limit movement of the jig on the top of the cup in all directions.

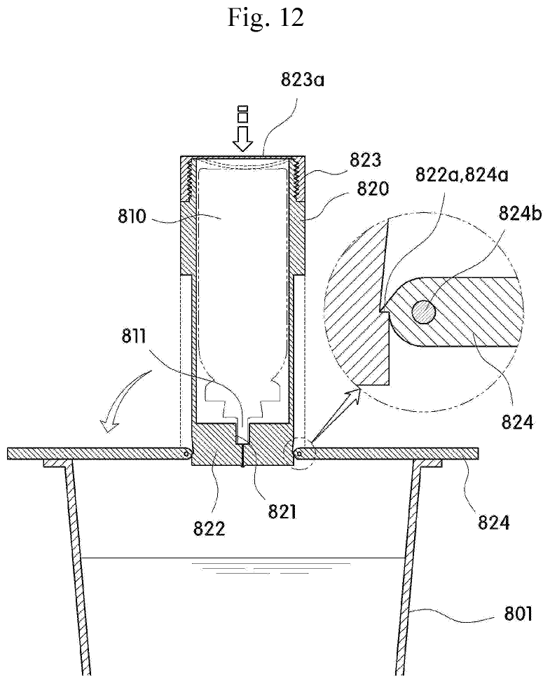

Referring to FIG. 12, a liquid beverage manufacturing device according to a sixth embodiment of the present invention is shown.

Referring to FIG. 12, the liquid beverage manufacturing device includes a pressure container 810 and a jig 820. The liquid beverage manufacturing device is integrally formed and easy to carry.

In the same manner as other embodiments, the pressure container 810 is filled with high pressure nitrogen and a liquid beverage and sealed, and when the discharge tube 811 is pushed toward the inside of the pressure container 810, the nitrogen and the liquid beverage are discharged through the discharge tube 811 due to an internal pressure.

The jig 820 in which the pressure container 10 is insertion-mounted includes a discharge hole 821 and a plurality of wing members 824, wherein the discharge hole 821 is formed in one end portion of the jig 820 and allows the discharge tube 811 to be inserted thereinto, and the plurality of wing members 824 are hinge-connected with lateral surfaces of the jig 820 and unfolded to be mounted on an upper surface of a cup 801 so as to support the pressure container 810.

In this case, when the discharge tube 811 is inserted into the discharge hole 821 by a predetermined depth and is pushed toward the inside of the pressure container 810 without further insertion, the discharge hole 821 allows the liquid beverage to be discharged therethrough. That is, the discharge hole 821 is formed in the same manner as in the above-described embodiments.

Referring to FIG. 12, the jig 820 is formed in a case shape, and the pressure container 810 is accommodated and mounted in the jig 820. Therefore, since the device is integrally formed, the device is easy to carry and very convenient.

The jig 820 may be formed in a cylindrical or box shape and includes a discharge hole 821 formed in a front member 822, which is one end portion thereof, and a stopper 823 formed on the opposite side to the front member 822 and attached or detached by screw-coupling.

In this case, in the jig 820, the stopper 823 is detachably coupled to a side opposite the discharge hole 821 and may be a flexible material to push a rear portion of the pressure container 810 without separation of the stopper. That is, a flat surface 823a of the stopper 823 is made of a thin synthetic resin or the like to prevent the pressure container 810 from coming out of the jig 820 and simultaneously push the pressure container 810 toward the discharge hole 821 even when the stopper 823 is not removed.

The plurality of wing members 824 are folded on lateral surfaces of the jig 820 but, as shown in FIG. 12, are unfolded at an angle of 90° to use when in use. In this case, the plurality of wing members 824 are mounted on a body of the jig 820 to be hinge-rotated by rotating pins 824b and the like and include protrusions 824a protrusion-formed adjacent to the rotating pins 824b, and projections 822a that block the protrusions 824a are formed on the jig 820, wherein, after the plurality of wing members 824 are rotated by an angle of 90° or more to be unfolded, the plurality of wing members 824 cannot return to an original position, and the protrusions 824a maintain an unfolded state at an angle of 90° or more.

As shown in FIG. 12, after the plurality of wing members 824 are unfolded, the unfolded state is maintained.

When a user pushes the stopper 823 formed on the rear portion of the jig 820 in a state in which the plurality of wing members 824 are unfolded at an angle of 90° or more, the user may make nitro coffee. Further, after the stopper 823 is separated, the user may directly push the pressure container 810.

Meanwhile, as another example, the plurality of wing members may be detachably coupled to the body of the jig. For example, while a plurality of wing members are inserted into a plurality of grooves, which are formed in a lateral surface of the body of the jig, the wing members may allow the body of the jig to be supported on the upper surface of the cup.

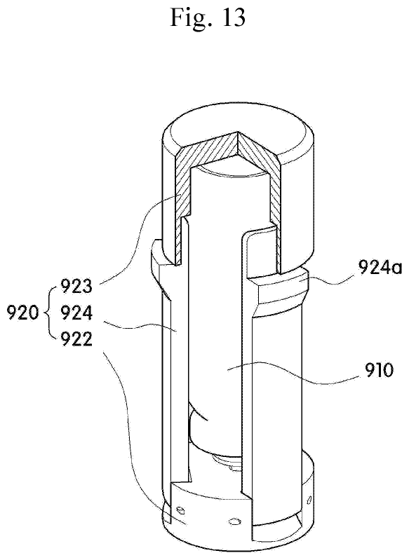

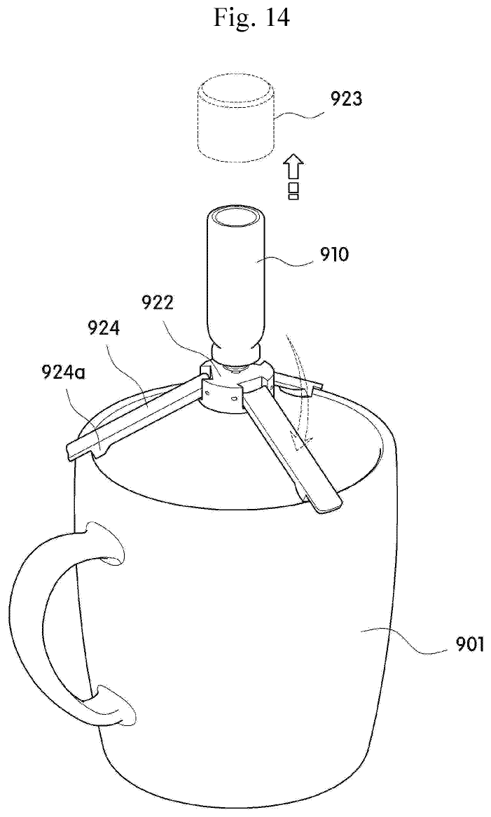

A seventh embodiment of a liquid beverage manufacturing device according to the present invention is shown in FIGS. 13 and 14.

In the same manner as the sixth embodiment, the liquid beverage manufacturing device includes a pressure container 910 and a jig 920.

The pressure container 910 has the same configuration as in the above-described embodiments.

The jig 920 is formed in a case shape and includes a front member 922, a plurality of wing members 924, and a stopper 923.

The front member 922 includes a discharge hole. In this case, any discharge hole in the above-described embodiments may be applied to the discharge hole. That is, the discharge hole is formed so that the discharge tube is inserted and an end portion of the discharge tube is caught therein.

The plurality of wing members 924 are rotatably mounted on the front member 922. Therefore, the plurality of wing members 924 have a structure that is unfolded from the front member 922 or returns to an original position.

In this case, one or more mounting protrusions 924a are provided to protrude from outer surfaces of the plurality of wing members 924. Referring to FIG. 14, the mounting protrusions 924a are mounted on an upper end of the cup 901.

The stopper 923 is assembled to cover a rear portion of the pressure container 910 and assembled to partially cover and surround the plurality of wing members 924 and a rear portion of the pressure container 910 while the plurality of wing members 924 are unfolded. Therefore, when the stopper 923 is assembled, the plurality of wing members 924 are in an unfoldable state. In this state, the device is carried.

In this case, since the stopper 923 is detachably assembled into the pressure container 910, the stopper 923 may be assembled in a forcible insertion manner. The stopper 923 has a protrusion formed in a circular arc direction and a groove in which the protrusion is mounted, and thus the stopper 923 may be assembled with the pressure container 910 so as to not be disassembled by any external force.

Referring to FIG. 14, a user first removes the stopper 923 and unfolds the plurality of wing members 924. In this case, three wing members are shown.

The user rotates the plurality of wing members 924 at an angle of 90° or more, and the mounting protrusions 924a are mounted on an inner upper end of the cup 901. Thus, the jig 920 and the pressure container 910 may be supported on the upper portion of the cup 901.

The user pushes the pressure container 910 so that the compressed nitrogen and the coffee are discharged and sprayed, and thus nitro coffee is made.

Meanwhile, as described above, the plurality of mounting protrusions 924a may be applied even to other cases in which a radius of the cup 901 is different from that of the above-described embodiment.

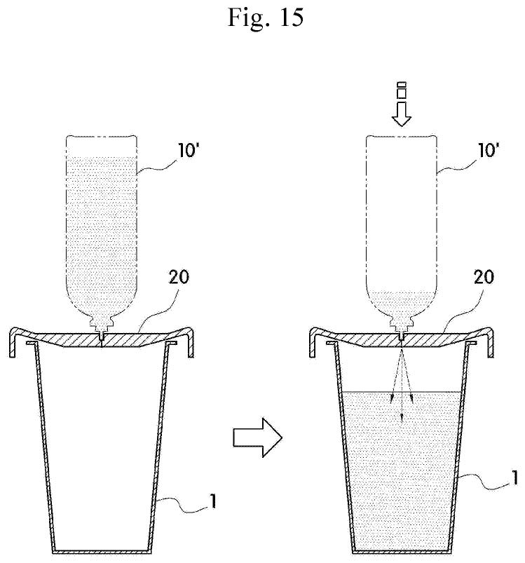

Meanwhile, in the above-described various embodiments, water is first supplied, and the compressed nitrogen and the concentrated coffee in the pressure container are mixed with the water, and thus nitro coffee is made. However, similar to an eighth embodiment in FIG. 15, when a pressure container 10′ is formed in a large size and water is injected into the pressure container 10′ filled with compressed nitrogen and coffee, as described in FIG. 15, only contents in the pressure container 10′ are sprayed without supplying water to the cup 1, and thus nitro coffee may be made.

Hereinabove, the embodiments of the present invention have been described, but the spirit of the present invention is not limited to the embodiments described in this specification. Those skilled in the art who understand the spirit of the present invention can easily suggest other embodiments within the scope of present invention by addition, modification, deletion, addition, etc., but this may also fall within the scope of the present invention.

### INDUSTRIAL APPLICABILITY

The liquid beverage manufacturing device according to the present invention is manufactured by a food and beverage manufacturer and is sold to customers, and the customers who bought the device can easily individually make and enjoy nitro coffee.

1.-12. (canceled)

13. A liquid beverage manufacturing device comprising:
a pressure container which is filled with high pressure nitrogen and a liquid beverage and sealed and allows the nitrogen and the liquid beverage to be discharged through a discharge tube due to an internal pressure when the discharge tube is pushed toward an inside of the pressure container; and
a jig including a discharge hole into which the discharge tube is inserted,
wherein, while the jig is positioned on an upper surface of a cup, the discharge tube is inserted into the discharge hole by a predetermined depth and is pushed toward the inside of the pressure container without further insertion, and thus the liquid beverage is discharged to an inside of the cup through the discharge hole.

14. The liquid beverage manufacturing device of claim 13, wherein the discharge hole includes an insertion part into which the discharge tube is inserted and a nozzle which has a reduced diameter so that an end portion of the discharge tube is caught therein.

15. The liquid beverage manufacturing device of claim 13, wherein a diameter of the discharge hole is linearly decreased.

16. The liquid beverage manufacturing device of claim 13, wherein the discharge hole includes a spiral groove or protrusion formed therein so that the discharged liquid beverage is spirally guided.

17. The liquid beverage manufacturing device of claim 13, wherein the jig is formed in a disc shape to cover an entirety of the upper surface of the cup.

18. The liquid beverage manufacturing device of claim 17, wherein the jig includes a gas hole that allows an upper portion of the jig to communicate with a lower portion thereof so that the inside of the cup communicates with an outside thereof while the jig covers the entirety of the upper surface of the cup.

19. The liquid beverage manufacturing device of claim 13, wherein the jig is formed in a hemispherical shape and includes an insertion groove formed in a central portion thereof so that a part or an entirety of the pressure container is inserted thereinto.

20. The liquid beverage manufacturing device of claim 13, wherein the jig is formed in a stopper shape.

21. The liquid beverage manufacturing device of claim 13, wherein the cup contains water to be mixable with the liquid beverage.

22. A liquid beverage manufacturing device comprising:
a pressure container which is filled with high pressure nitrogen and a liquid beverage and sealed and allows the nitrogen and the liquid beverage to be discharged through a discharge tube due to an internal pressure when the discharge tube is pushed toward an inside of the pressure container; and
a jig in which the pressure container is insertion-mounted and which includes a discharge hole formed in one end portion thereof so that the discharge tube is inserted into the discharge hole and a plurality of wing members formed on lateral surfaces of the jig and mounted on an upper surface of a cup to support the pressure container,
wherein, while the jig is mounted on the upper surface of the cup, the discharge tube is inserted into the discharge hole by a predetermined depth and is pushed toward the inside of the pressure container without further insertion, and thus the liquid beverage is discharged to an inside of the cup through the discharge hole.

23. The liquid beverage manufacturing device of claim 22, wherein the plurality of wing members are hinge-connected with the lateral surface of the jig or detachably.

24. The liquid beverage manufacturing device of claim 22, wherein the discharge hole includes an insertion part into which the discharge tube is inserted and a nozzle which has a reduced diameter so that an end portion of the discharge tube is caught therein.

25. The liquid beverage manufacturing device of claim 22, wherein a diameter of the discharge hole is linearly decreased.

26. The liquid beverage manufacturing device of claim 22, wherein the discharge hole includes a spiral groove or protrusion formed therein so that the discharged liquid beverage is spirally guided.

27. The liquid beverage manufacturing device of claim 22, wherein the jig includes a stopper detachably coupled to a side opposite the discharge hole, wherein the stopper is made of a flexible material to push a rear portion of the pressure container without separation of the stopper.

28. The liquid beverage manufacturing device of claim 22, wherein the cup contains water to be mixable with the liquid beverage.
